(19) United States
(12) Patent Application Publication
(10) Pub. No.: US 2001/0034833 A1
(43) Pub. Date: Oct. 25, 2001

(54) Certificating system for plurality of services and method thereof

(76) Inventors: Isao Yagasaki, Kawasaki (JP); Toshimitsu Kuroda, Kawasaki (JP)

Correspondence Address: STAAS & HALSEY LLP, 700 11TH STREET, NW, SUITE 500, WASHINGTON, DC, 20001, US

(21) Appl. No.: 09/749,428

(22) Filed: Dec. 28, 2000

(30) Foreign Application Priority Data
Apr. 21, 2000 (JP) 2000-121581

(51) Int. Cl. H04L 9/32; H04L 12/22

(52) U.S. Cl. 713/156; 713/201

(57) ABSTRACT

When a user presents a common certificate in common with a plurality of services and accesses to one of those services, the system determines whether or not the certificate corresponds to a pre-registered certificate. When the user's certificate corresponds to the pre-registered certificate, the system permits the use to use the accessed service.

### BACKGROUND OF THE INVENTION

1. Field of the Invention

The present invention relates to a service through a network such as the Internet. In particular, the present invention relates to a certificating system and a method for certificating a user who uses a plurality of services.

2. Description of the Related Art

A service provider on a network should certificate a user who is accessing the network so as to charge the user for a service fee. In a conventional service system, when one user uses a plurality of services, the uses different certificating methods designated by the individual services.

FIG. 1 shows such a conventional service system. When user 11 uses two services A and B, the user 11 sends identification (ID) and a password (PWD) for the service A to a server 12 of the service A. The server 12 references a user management database (user management DB) 13, certificates the user, and provides the service A to the user 11.

The user 11 sends an ID and a password for the service B to a server 14 of the service B. The server 14 references a user management DB 15, certificates the user, and provides the service B to the user 11. In such a manner, the user 11 can use the network services A and B.

However, the above-described conventional service system has the following problems.

When one user uses a plurality of network services, the user should inconveniently use an unique ID and an unique password for each of the network services. In particular, when different IDs and passwords are pre-assigned to individual services, the user should memorize them and input an appropriate ID and an appropriate password corresponding to a desired service on a terminal unit. Thus, when the number of services that the user uses increases, the load of the user increases.

Alternatively, corresponding to a conventional certifying method using a unique ID and a unique password, a particular service may use an ID and a password that a user has registered to another service. However, when those service providers are different business organizations, the service provider of the particular service can know the password for the other service. Thus, such a certificating method is impractical from a view point of security.

### SUMMARY OF THE INVENTION

An object of the present invention is to provide a certificating system and a method thereof that allow the load of the user to alleviate in a certificating process for a plurality of services while keeping a password and so forth issued by individual services secret.

A certificating system according to the present invention comprises a registering device, a receiving device, a determining device, and a permitting device. The registering device registers certificate information in common with a plurality of services. The receiving device receives certificate information of a user when the user accesses a particular service of those. The determining device determines whether or not the certificate information of the user corresponds to the common certificate information. The permitting device permits the user to use the particular service that the user accesses when the certificate information of the user corresponds to the common certificate information.

These and other objects, features and advantages of the present invention will become more apparent in light of the following detailed description of a best mode embodiment thereof, as illustrated in the accompanying drawings.

### BRIEF DESCRIPTION OF DRAWINGS

FIG. 1 is a schematic diagram showing the structure of a conventional certificating system;

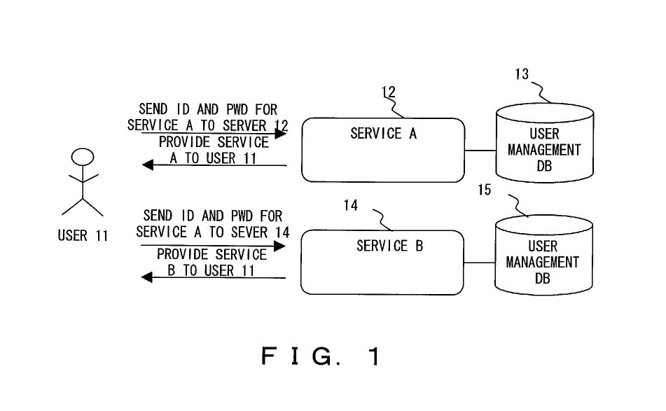

FIG. 2 is a block diagram showing the theory of a processing system according to the present invention;

FIG. 3A is a schematic diagram showing an issuing process and a qualifying process for a certificate;

FIG. 3B is a schematic diagram showing an invalidating process for a certificate;

FIG. 4 is a schematic diagram showing a certificating process using a certificate;

FIG. 5 is a schematic diagram showing a certificate management table;

FIG. 6 is a schematic diagram showing an available service management table;

FIG. 7 is a schematic diagram showing a user information management table;

FIG. 8 is a flow chart showing an issuing process and invalidating process for a certificate;

FIG. 9 is a flow chart showing a qualifying process for a certificate;

FIG. 10 is a block diagram showing the structure of a service system;

FIG. 11 is a schematic diagram showing an example of the use of a plurality of services;

FIG. 12 is a block diagram showing the structure of an information processing unit; and

FIG. 13 is a schematic diagram showing a record medium.

### DESCRIPTION OF PREFERRED EMBODIMENT

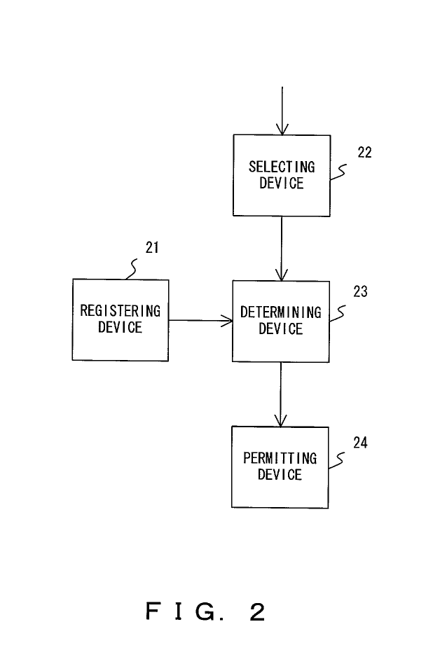

Next, with reference to the accompanying drawings, an embodiment of the present invention will be described. FIG. 2 is a block diagram showing the theory of a certificating system according to the present invention. A certificating system shown in FIG. 2 comprises a registering device 21, a receiving device 22, a determining device 23, and a permitting device 24. The registering device 21 registers certificate information in common with a plurality of services. The receiving device 22 receives certificate information of a user when the user accesses a particular service of those. The determining device 23 determines whether or not the certificate information of the user corresponds to the common certificate information. The permitting device 24 permits the user to use the particular service that the user accesses when the certificate information of the user corresponds to the common certificate information.

The user has certificate information in common with a plurality of service. The certificate information is pre-issued to the user. When the user uses one of the services, the user sends the certificate information from the user terminal.

When the receiving device 22 receives the certificate information, the receiving device 22 sends the information to the determining device 23. The determining device 23 compares the received certificate information with the certificated information registered in the registering device 21 and determines whether or not the former corresponds to the latter. The determined result is sent to the permitting device 24. When the former corresponds to the latter as the determined result of the determining device 24, the permitting device 24 permits the user to use the service.

According to such a certificating system, the user can use a plurality of services using one piece of certificate information instead of a unique ID and a unique password for each service. Thus, the user does not need to handle a plurality of IDs and a plurality of passwords. As a result, the load of the user alleviates.

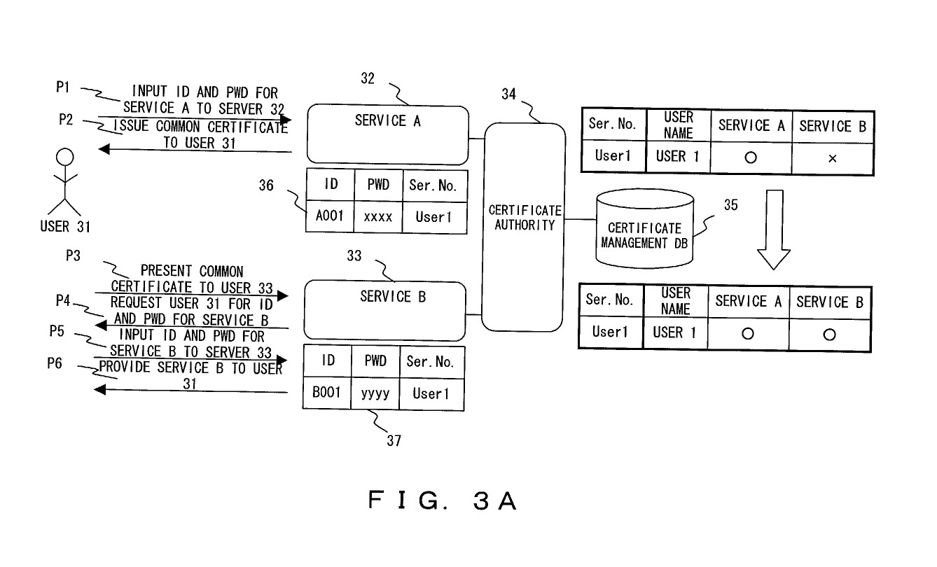

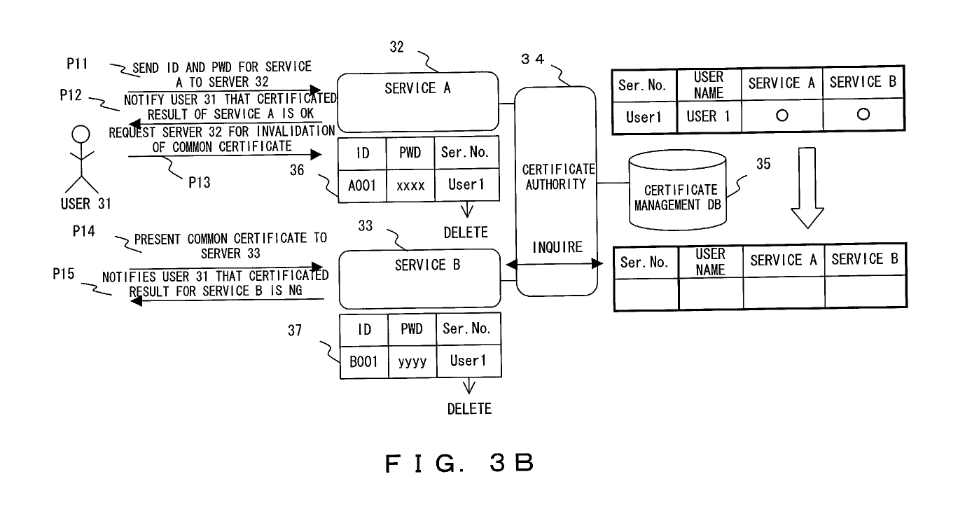

For example, the registering device 21 shown in FIG. 2 corresponds to a user information management table 36 shown in FIG. 3A (that will be described later). The receiving device 22, the determining device 23, and the permitting device 24 shown in FIG. 2 correspond to servers 32 and 33 shown in FIG. 3A. Alternatively, the registering device 21 shown in FIG. 2 corresponds to a certificate management DB 35 shown in FIG. 3A. In addition, the receiving device 22, the determining device 23, and the permitting device 24 shown in FIG. 2 correspond to a certificate authority 34.

In a certificating system according to the embodiment, when the user presents one digital certificate to a plurality of independent network services, the certificating system permits the user to use those services. The certificating system issues a digital certificate to only a user certificated by a predetermined certificating method. The digital certificate represents that the user can use a plurality of services.

The digital certificate is generated by a certificate authority that digitally signing data of which a user name, a certificate issuer, a serial number, a user's public key, and so forth are integrated corresponding to Specification X. 509 of ITU-U (International Telecommunication Union Telecommunication Standardization Sector). The certificate authorizes that the public key contained therein belongs to the user.

FIG. 3A shows an issuing process and a qualifying process for a digital certificate performed by such a certificating system. In FIG. 3A, services A and B are membership services using IDs and passwords. Services 32 and 33 provide the services A and B to a user 31, respectively. A certificate authority 34 is a certificate issuing organization that is independent from the service providers. The certificate authority 34 issues a digital certificate that is common with the services A and B to the user 31. The digital certificate is referred to as common certificate.

To allow the user 31 to be certificated with the common certificate, the certificate authority 34 should issue a common certificate to the user 31. In that case, the certificate authority 34 issues a common certificate to the user 31 through the service A. When the user 31 initially accesses the service B, the server 33 qualifies the common certificate. The servers 32 and 33 contain user information management tables 36 and 37, respectively. Each of the information management tables 36 and 37 contain an ID, a password, and so forth of the user 31. In that case, the following process is performed in this sequence.

P1: The user 31 sends the ID and the password for the service A to the server 32. The server 32 references the user information management table 36 and certificates the user 31. When the certificated result is OK, the server 32 requests the certificate authority 34 to issues the common certificate.

P2: The server 32 receives the common certificate from the certificate authority 34 and issues the common certificate to the user 31. At that point, the common certificate that the user 31 has certificates the use of only the service A. A certificate management DB 35 of the certificate authority 34 contains the relevant user name and information that represents the validity of the use of the service A along with identification information (for example, a serial number) of the common certificate. The user information management table 36 contains a serial number (Ser. No.) of the common certificate along with the ID and the password.

P3: The user 31 presents the issued common certificate to the server 33.

P4: The server 33 determines that the present common certificate does not certificate the use of the service B and request the user 31 for the ID and the password for the service B.

P5: The user 31 sends the ID and the password for the service B to the server 33.

P6: The server 33 references the user information management table 37 and certificates the user. When the certificated result is OK, the server 33 provides the service B to the user 31. Thereafter, the common certificate that the user 31 has allows the user 31 to use the service B. At that point, the common certificate that the user 31 has certificates the use of the services A and B. The certificate management DB 35 contains information that represents the validity of the use of the services A and B. In addition, the user information management table 37 contains the serial number of the common certificate along with the ID and the password.

At steps P1 and P5, the user is certificated with IDs and passwords. Alternatively, the user may be certificated with another certificating method using finger print information, voice print information, picture information, or the like. When the user wants to quit the use of a service, the user performs an invalidating process for the common certificate or a service use prohibiting process. When the user performs the invalidating process for the common certificate, the following process is performed in this sequence as shown in FIG. 3B.

P11: The user 31 sends the ID and the password for the service A or the common certificate to the server 32.

P12: When the server 32 receives the ID and the password, the server 32 references the user information management table 36 and certificates the user 31. When the certificated result is OK, the server 32 notifies the user 31 that the certificated result is OK. When the server 32 receives the common certificate, the server 32 certificates the user 31 in a predetermined certificating method (that will be described later) and notifies the user 31 of the certificated result.

P13: The user 31 requests the server 32 for the invalidation of the common certificate that the user 31 has. The server 32 notifies the certificate authority 34 of the serial number of the common certificate and requests the certificate authority 34 to perform the invalidating process for the common certificate. The certificate authority 34 deletes the information of the common certificate from the certificate management DB 35. The server 32 deletes the serial number of the common certificate from the user information management table 36.

P14: Thereafter, the user 31 presents the common certificate that the user 31 has as certification information to the server 33. The server 33 notifies the certificate authority 34 of the serial number of the presented common certificate and inquires the certificate authority 34 for the validity of the common certificate.

P15: Since the notified serial number has not been registered to the certificate management DB 35, the certificate authority 34 notifies the server 33 that the checked result is NG. The server 33 deletes the serial number of the common certificate from the user information management table 37 and notifies the user 31 of the invalidity of the use of the service B.

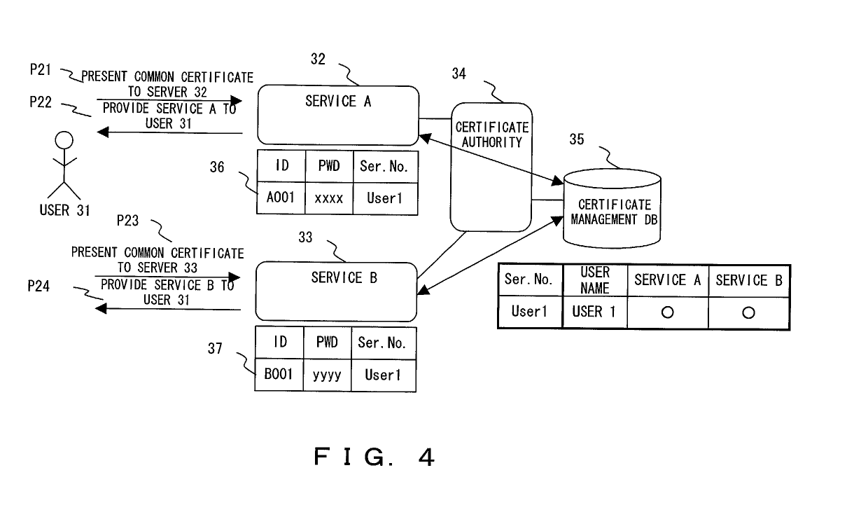

FIG. 4 shows a user certificating process using an issued common certificate. In the case, a service is provided in the following sequence.

P21: The user 31 presents a common certificate that the user 31 has as certification information to the server 32. The server 32 notifies the certificate authority 34 of the serial number of the presented common certificate and requests the certificate authority 34 to check for the common certificate. The certificate authority 34 references the certificate management DB 35 and checks whether or not the notified serial number has been registered thereto. When the notified serial number has been registered and the service A can be used, the certificate authority 34 returns OK as the checked result to the server 32.

P22: When the server 32 receives OK from the certificate authority 34, the server 32 provides the service A to the user 31.

P23: The user 31 presents the common certificate that the user 31 has as certification information to the server 33. The server 33 receives the checked result from the certificate authority 34 in the same manner as the server 32.

P24: When the server 33 receives OK from the certificate authority 34, the server 33 provides the service B to the user 31.

In that example, the case that the user uses two services was described. This applies to the case that the user uses three or more services. The servers 32 and 33 request the certificate authority 34 for checking for the common certificate so as to determine whether the presented common certificate is invalid. However, it should be noted that the checking step can be omitted.

In that case, in the invalidating step, the certificate authority 34 notifies all servers of relevant services of the serial number of the invalidated common certificate. Each server deletes the serial number from the user information management table. When the user presents the common certificate to a particular server, if the serial number has been registered to a relevant user information management table, the certificated result is OK. If the serial number has not been registered, the certificated result is NG.

In the certificating system shown in FIGS. 3A, 3B, and 4, the user can use a plurality of service by presenting only a common certificate without need to use designated IDs and passwords for the individual services. Thus, the user does not need to memorize a plurality of IDs and passwords. In addition, whenever the user uses a service, the user does not need to input relevant ID and password. Thus, the user's load significantly alleviates.

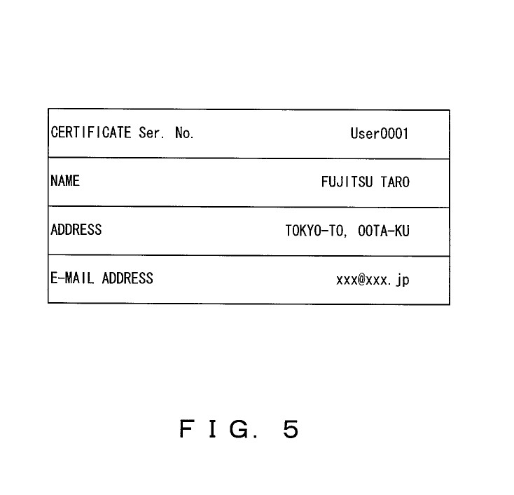

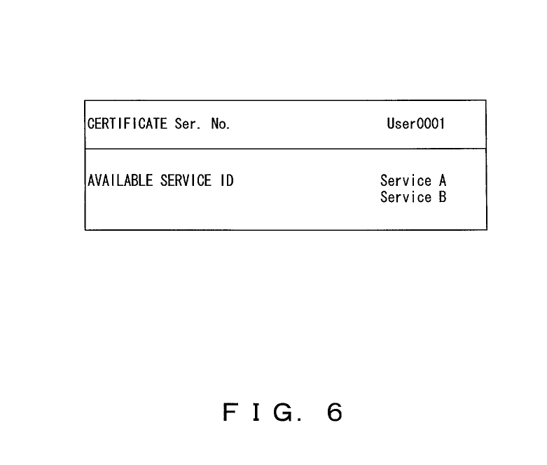

The certificate management DB 35 contains a certificate management table shown in FIG. 5 and an available service management table shown in FIG. 6. The certificate management table shown in FIG. 5 contains a serial number, a user name, an address, and an e-mail address of a common certificate. The available service management table shown in FIG. 6 contains a serial number and an available service ID of a common certificate. The certificate management table and the available service management table are generated for each common certificate.

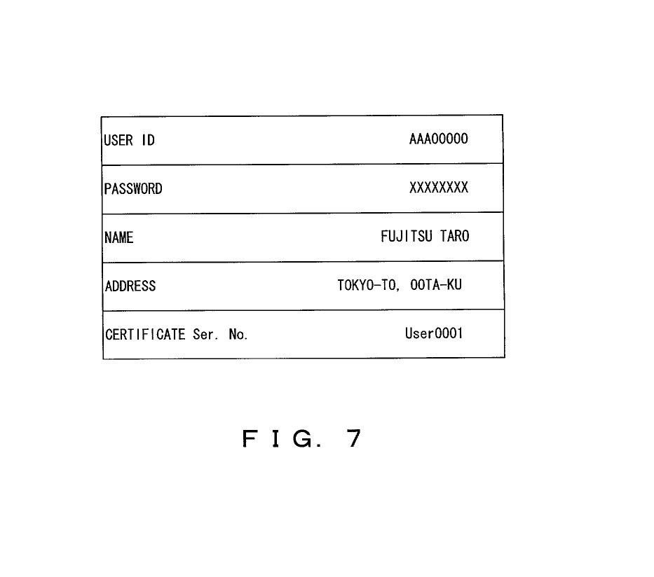

FIG. 7 shows an example of the user information management tables 36 and 37. The user information management table shown in FIG. 7 contains a user ID, a password, a user's name, a use's address, and a serial number of a common certificate. The user information management table is generated for each user.

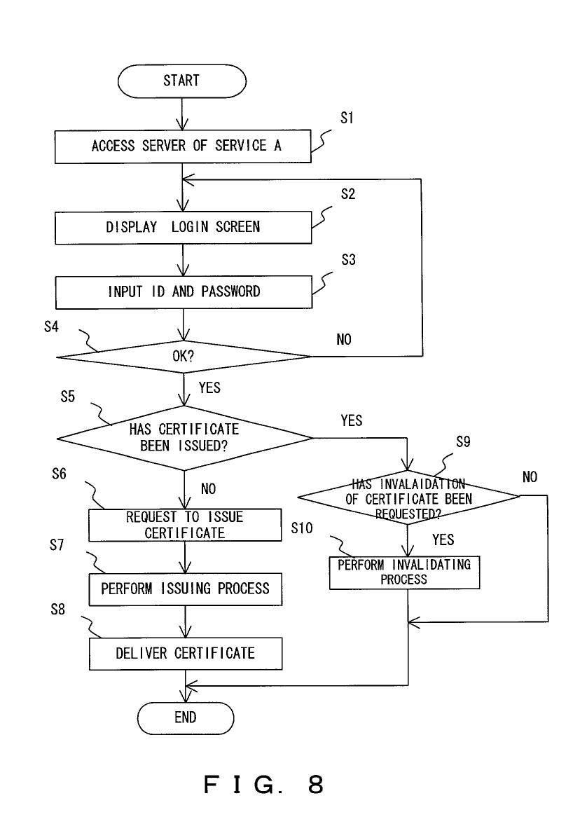

FIG. 8 is a flow chart showing a process performed in the case that the user 31 requests the server 32 of the service A to issue or invalidate a common certificate. First of all, the user 31 accesses the server 32 (at step S1). The server 32 displays a login screen on the user's terminal unit (at step S2). Thereafter, the user 31 inputs an ID and a password for the service A (at step S3). The server 32 references the user information management table 36 and checks for the input ID and password (at step S4).

When the determined result at step S4 is No (namely the input ID and password are not valid), the server 32 repeats the process from step S2. When the determined result at step S4 is Yes (namely, the input ID and password are valid), the server 32 references the user information management table 36 and checks whether or not a common certificate has been issued to the user 31 (at step S5).

When the determined result at step S5 is No (the serial number of the use's common certificate has not been registered to the user information management table 36), the server 32 determines that the common certificate has not been issued to the user 31 and requests the certificate authority 34 to issue the common certificate (at step S6).

Thus, the certificate authority 34 issues the common certificate (at step S7). At that point, the certificate authority 34 generates a certificate management table that contains the serial number of the common certificate and the user information. In addition, the certificate authority 34 generates an available service management table that contains the serial number of the common certificate and the ID of the service A. The certificate authority 34 places those tables to the certificate management DB 35.

Thereafter, the server 32 delivers the issued common certificate to the user 31. The server 32 records the serial number of the common certificate to the user information management table 36 (at step S8). Thereafter, the server 32 completes the process.

When the determined result at step S5 is Yes (namely, the user information management table 36 contains the serial number of the common certificate), the server 32 notifies the user 31 that the common certificate has been issued and inquires the user 31 whether or not the user 31 want to invalidate the common certificate (at step S9). When the determined result at step S9 is No (namely, the user 31 does not want to invalidate the common certificate), the server 32 completes the process.

When the determined result at step S9 is Yes (namely, the user wants to invalidate the common certificate), the server 32 notifies the certificate authority 34 of the serial number of the common certificate and requests the certificate authority 34 to invalidate it (at step S10). Thus, the certificate authority 34 deletes the certificate management table and the available service management table corresponding to the notified serial number and notifies the server 32 of the processed result. The server 32 deletes the serial number of the common certificate from the user information management table 36 and notifies the user 31 that the common certificate has been invalided. Thereafter, the server 32 completes the process.

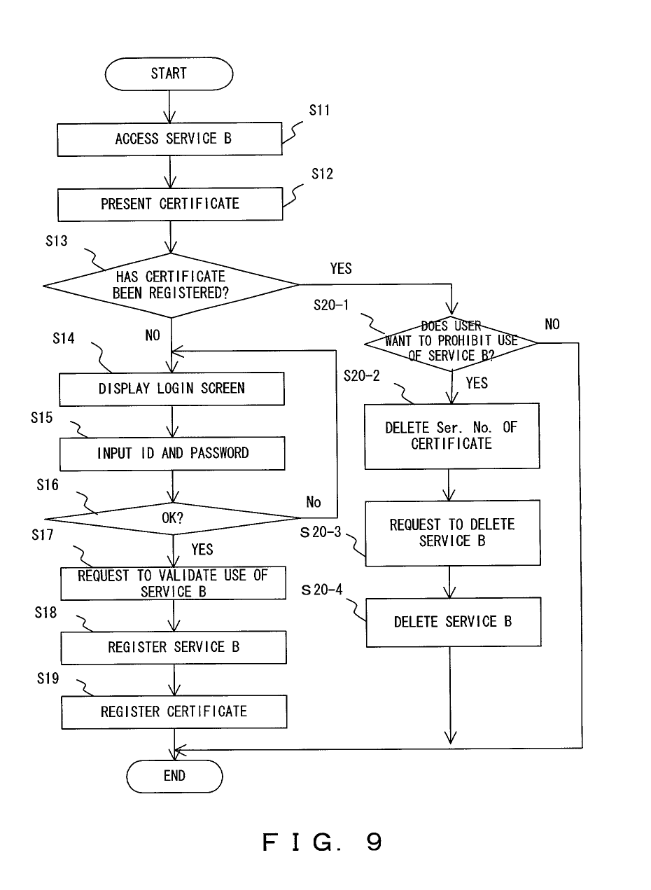

FIG. 9 is a flow chart showing a process in the case that the user 31 requests the server 33 to qualify a common certificate that the user 31 has. First of all, the user 31 accesses the server 33 (at step S11) and presents the common certificate thereto (at step S12).

Thereafter, the server 33 checks whether the user information management table 37 contains the serial number of the presented common certificate (at step S13). When the determined result at step S13 is No (namely, the user information management table 37 does not contain the serial number), the server 33 performs the process at steps S14 to S16 that are the same steps as steps S2 to S4, respectively.

When the determined result at step S16 is Yes (namely, the ID and the password are valid), the server 33 notifies the certificate authority 34 of the serial number of the presented common certificate and requests the certificate authority 34 to validate the use of the service B with the common certificate (at step S17).

Thus, the certificate authority 34 adds the ID of the service B to an available service management table corresponding to the notified serial number and notifies the server 33 of the validity of the use of the service B (at step S18). Thereafter, the server 33 records the serial number of the common certificate to the user information management table 37 (at step S19). Thereafter, the process is completed.

When the determined result at step S13 is Yes (namely, the user information management table 37 contains the serial number of the common certificate), the server 33 inquires the user 31 whether or not the user 31 want to prohibit the use of the service B (at step S20-1). When the determined result at step S20-1 is No (namely, the user does not want to prohibit the use of the service B), the server 33 completes the process.

When the determined result at step S20-1 is Yes (namely, the user wants to prohibit the use of the service B), the server 33 deletes the serial number of the presented common certificate from the user information management table 37 (at step S20-2) and requests the certificate authority 34 to delete the service B from the available service of the common certificate (at step S20-3).

Thus, the certificate authority 34 deletes the service ID of the service B from the relevant available service management table and notifies the server 33 that the service B has been deleted (at step S20-4). Thereafter, the server 33 notifies the user 31 that the use of the service B has been prohibited. Thereafter, the server 33 completes the process.

In the above-described example, the certificate management table and the available service management table are independently provided. Alternatively, information of those tables may be contained in one table.

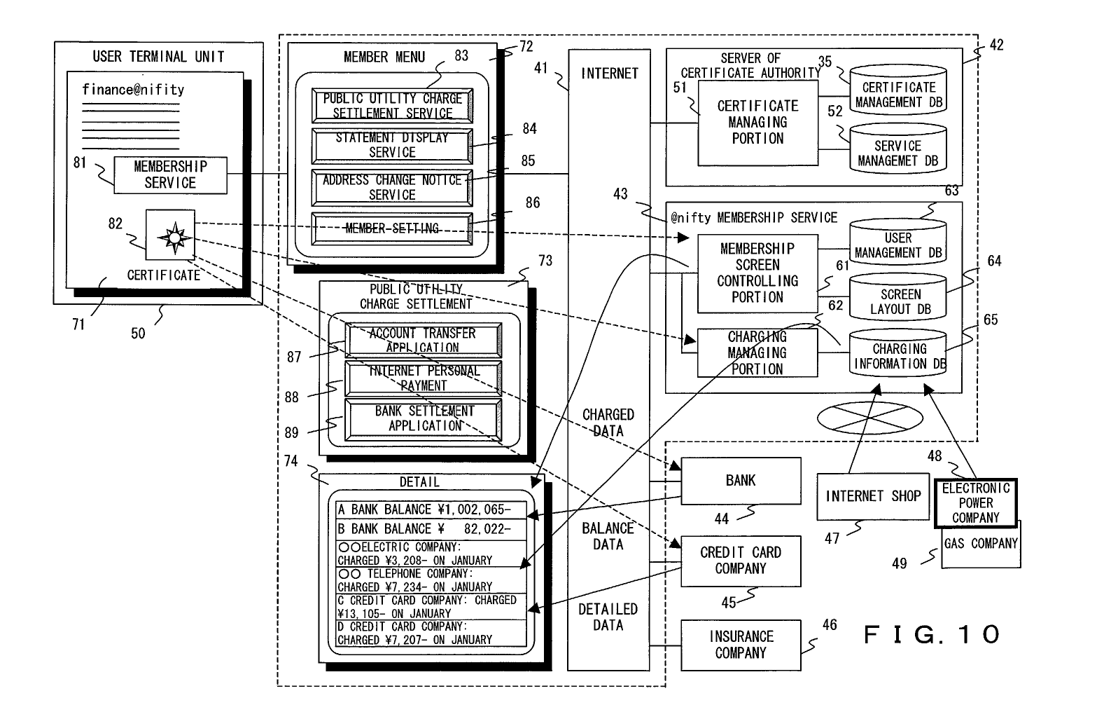

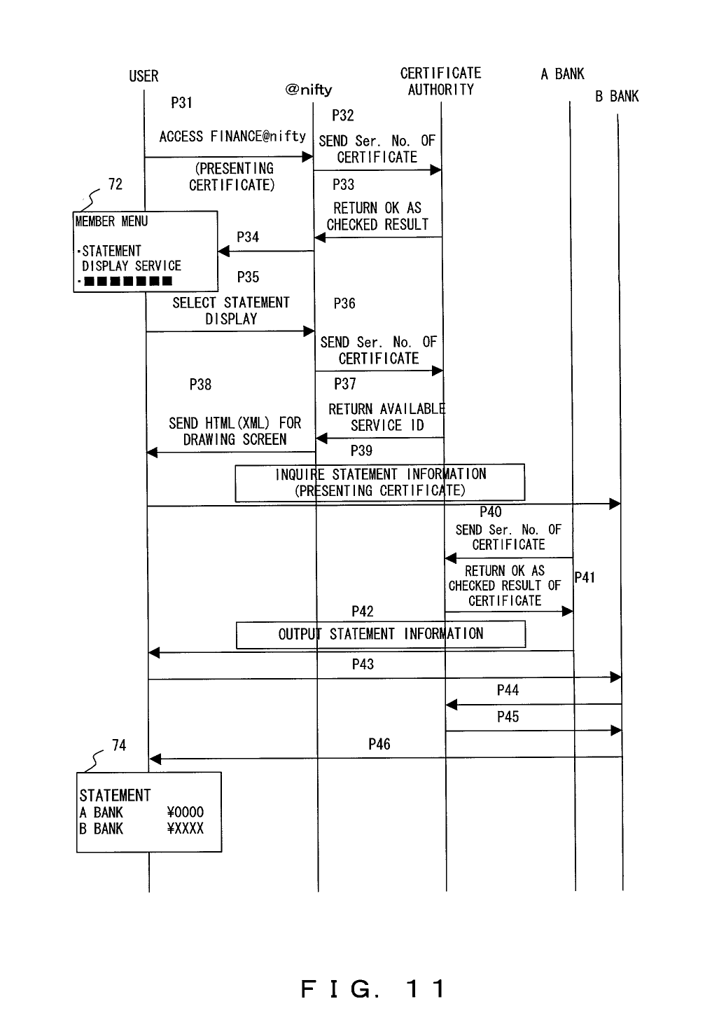

Next, with reference to FIGS. 10 and 11, an example of which the above-described certificating system is applied to Nifty, which is an Internet membership service.

Many companies provide services as portal sites on Nifty. A portal site, which is a huge web site that is a gate of the Internet, has links to various service sites. However, when a plurality of independent services are concentrated to a portal site, the certificating process becomes complicated. Besides Nifty, such a problem takes place at any portal site. In that situation, using the above-described common certificate, the certificating process can be simply performed for a plurality of services.

FIG. 10 is a block diagram showing the structure of a service system including a portal site Finance@nifty, which provides financial services. The service system shown in FIG. 10 comprises the Internet 41, a server 42 of a certificate authority, a server 43 of a @nifty membership service, a server 44 of a bank, a server 45 of a credit card company, a server 46 of an insurance company, a server 47 of an Internet shop, a server 48 of an electric power company, a server 49 of a gas company, and a user terminal unit 50.

In the example, the @nifty, the bank, the credit card company, the insurance company, the Internet shop, the electric power company, and the gas company are independent business organizations that provide respective membership services.

The server 42 of the certificate authority comprises a certificate management DB 35, a certificate managing portion 51, and a service management database 52. The certificate management DB 35 contains a certificate management table and an available service management table for each common certificate. The certificate managing portion 51 for example issues, checks, and invalidates a common certificate using the certificate management DB 35. The service management DB 52 contains information about each service. The certificate managing portion 51 performs a membership qualifying process for each service.

The server 43 of the @nifty membership service comprises a membership screen controlling portion 61, a charging managing portion 62, a user management DB 63, a screen layout DB 64, and a charging information DB 65. The user management DB 63 contains a user information management table of each user. The screen layout DB 64 contains data of a membership service screen. The charging information DB 65 contains data of charged amount collected from the servers 47, 48, and 49 and so forth.

The membership screen controlling portion 61 controls a screen display of the user terminal unit 50 using the user management DB 63 and the screen layout DB 64. The charging managing portion 62 controls a screen display of the charged amount using the charging information DB 65.

For example, a page 71 of the Finance@nifty displayed on the user terminal unit 50 contains items of a membership service 81 and a certificate 82. When the user designates those items, the user terminal unit 50 automatically sends its common certificate to the server 43. The server 43 certificates the user with the common certificate. When the user has been successfully certificated, the user terminal unit 50 displays a page 72 of a member menu. The page 72 contains items of a public utility charge settlement service 83, a statement display service 84, an address change notice service 85, and a member setting 86.

When the user selects the public utility charge settlement service 83, the user terminal unit 50 sends the common certificate to the server 44. The server 44 certificates the user with the common certificate. When the user has been successfully certificated, the user terminal unit 50 displays a page 73 of public utility charge settlement. The page 73 contains items of account transfer application 87, Internet personal payment 88, and bank settlement application 89.

When the user selects the statement display service 84, the user terminal unit 50 displays a page 74 of user's detailed financial information. At that point, when necessary, the user terminal unit 50 sends the common certificate to the servers 44 and 45. The servers 44 and 45 certificate the user.

The layout data of the page 74 is supplied from the membership screen controlling portion 61. The data of the charged amount is supplied from the charging managing portion 62. The balance data of the bank account is supplied from the server 44 of the bank. The charge settlement data of the credit card is supplied from the server 45 of the credit card company.

FIG. 11 shows a process of which a user uses the statement display service 84 in the service system shown in FIG. 10. In the process, a plurality of services of business organizations such as @nifty, a bank, and a credit card company are provided in the following sequence.

P31: The user accesses the Finance@nifty site with the common certificate on the user terminal unit 50.

P32: The server 43 of the @nifty membership service notifies the server 42 of the certificate authority of the serial number of the common certificate.

P33: The server 42 references a relevant available service management table of the certificate management DB 35. When the common certificate represents the validity of the @nifty membership service, the server 42 returns OK as the checked result to the user terminal unit 50.

P34: The server 43 causes the user terminal unit 50 to display the member menu 72.

P35: The user selects the statement display service from the member menu 72.

P36: The server 43 notifies the server 42 of the certificate authority of the serial number of the common certificate and inquires the server 42 of the certificate authority for available services corresponding to the notified serial number.

P37: The server 42 references a relevant available service management table, obtains an available service ID corresponding to the notified serial number, and returns it to the server 43.

P38: The server 43 sends layout data for drawing a screen including a display region corresponding to the received service ID to the user terminal unit 50. The layout data is described in HTML (HyperText Markup Language), XML (extensible Markup Language) or the like.

P39: The user terminal unit 50 inquires the server of the A bank for statement information with the common certificate.

P40: The server of the A bank notifies the server 42 of the certificate authority of the serial number of the presented common certificate.

P41: The server 42 references a relevant available service management table of the certificate management DB 35. When the common certificate represents the validity of the service of the A bank, the server 42 of the certificate authority returns OK as the checked result to the user terminal unit 50.

P42: The server of the A bank sends balance data of the user's account as the statement information to the user terminal unit 50.

P43 to P46: The server of the B bank sends balance data of the user's account to the user terminal unit 50 corresponding to the certificated result of the common certificate in the same manner as the server of the A bank.

As a result, the user terminal unit 50 displays the statement page 74. In the same manner, the server 45 of the credit card company and the server 46 of the insurance company can provide the statement information of the statement page 74.

According to the service system shown in FIG. 10, statement information such as account balances and charged amounts of individual services can be integrally displayed on one layout screen. Thus, the user can transversely use a plurality of services. In FIG. 10, the function of the certificate authority is independent from each service. Alternatively, the function of the certificate authority may be contained in the @nifty membership service.

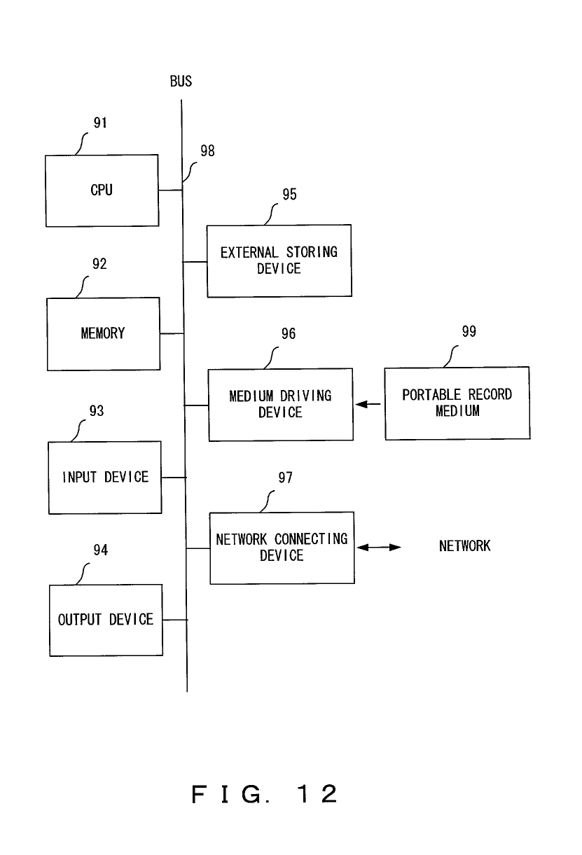

The servers 42 to 49 and the user terminal unit 50 shown in FIG. 10 can be composed of an information processing unit (computer) shown in FIG. 12. The information processing unit shown in FIG. 12 comprises a CPU (Central Processing Unit) 91, a memory 92, an input device 93, an output device 94, an external storing device 95, a medium driving device 96, and a network connecting device 97. These devices are connected by a bus 98.

The memory 92 includes for example a ROM (Read Only Memory) and a RAM (Random Access Memory). The memory 92 stores programs and data. The CPU 91 executes a program using the memory 92 so as to perform a desired process.

For example, the certificate managing portion 51, the membership screen controlling portion 61, and the charging managing portion 62 shown in FIG. 10 are stored as software components that are described as programs to the memory 92.

The input device 93 includes for example a keyboard, a pointing device, and a touch panel. The input device 93 is used to input a command and information. The input device 93 is used by the operator (a service provider or a user). The output device 94 includes for example a display device, a printer, and a speaker. The output device 94 is used to prompt a user for data and to output processed results.

The external storing device 95 is for example a magnetic disc device, an optical disc device, a magneto-optical disc device, or a tape device. The information processing unit stores the above-described programs and data to the external storing device 95. When necessary, the information processing unit loads the programs and data to the memory 92. The external storing device 95 may be used for the certificate management DB 35, the service management DB 52, the user management DB 63, the screen layout DB 64, and the charging information DB 65 shown in FIG. 10.

The medium driving device 96 drives a portable record medium 99 and accesses the contents thereof. The portable record medium 99 is for example a memory card, a floppy disk, a CD-ROM (Compact Disc Read Only Memory), an optical disc, or a magneto-optical disc from which any computer can read data. The operator stores the above-described programs and data to the portable record medium 99. When necessary, the operator loads the programs and data to the memory 92.

The network connecting device 97 is connected to any communication network such as Internet 41. The network connecting device 97 converts data so as to communicate with the communication network. The information processing unit receives the above-described programs and data from another device through the network connecting device 97. When necessary, the information processing unit loads the programs and data to the memory 92.

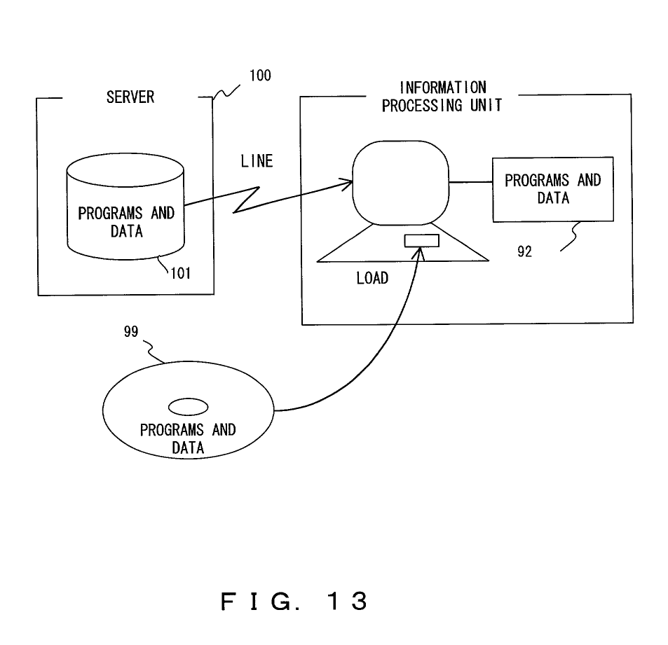

FIG. 13 shows a record medium from which a computer can read a program and data and supply them to the information processing unit shown in FIG. 12. The programs and data stored in the portable record medium 99 and a database 101 of a server 100 are loaded to the memory 92. At that point, the server 100 generates a transfer signal for transferring programs and so forth and transmits them to the information processing unit through any transfer medium on the network. The CPU 91 executes the programs with the data so as to perform a required process.

According to the above-described embodiment, the digital certificate corresponding to ITU-T Specification X.509 is used as certification information. When necessary, certification information corresponding to another specification may be used.

According to the present invention, with one piece of certification information in common with a plurality of services, the user can be certificated for each service. Thus, the user does not need to use different IDs and passwords issued by the individual services. Thus, the load of the user alleviates. In addition, it is not necessary to exchange a password and so forth among different services. Thus, the security of the system is maintained.

Although the present invention has been shown and described with respect to a best mode embodiment thereof, it should be understood by those skilled in the art that the foregoing and various other changes, omissions, and additions in the form and detail thereof may be made therein without departing from the spirit and scope of the present invention.

What is claimed is:

1. A certificating system, comprising:
a registering device registering common certificate information in common with a plurality of services;
a receiving device receiving certificate information of a user when the user accesses a particular service of the plurality of services;
a determining device determining whether or not the certificate information of the user corresponds to the common certificate information; and
a permitting device permitting the user to utilize the particular service when the certificate information of the user corresponds to the common certificate information.

2. The certificating system as set forth in claim 1, further comprising:
a storing device storing identification information and password information for the particular service;
a certifying device certifying the user based on the identification information and the password information; and
an issuing device issuing the common certificate information to the user when said certifying device has successfully certified the user.

3. The certificating system as set forth in claim 1, further comprising:
a storing device storing identification information and password information for the particular service;
a certifying device certifying the user based on the identification information and the password information; and
an invalidating device for invalidating the common certificate information when said certifying device has successfully certified the user.

4. The certificating system as set forth in claim 1, further comprising:
an available service managing device registering the plurality of services as available services with the common certificate information.

5. A terminal unit, comprising:
a transmitting device transmitting common certificate information in common with a plurality of services when a user accesses a particular service of the plurality of services; and
a service utilizing device providing the particular service to the user when the user has been successfully certified based on the common certificate information.

6. A computer-readable recording medium on which a program for a computer is recorded, said program causing the computer to perform:
receiving certificate information of a user when the user accesses a particular service of a plurality of services;
determining whether or not the certificate information of the user corresponds to common certificate information in common with the plurality of services; and
permitting the user to utilize the particular service when the certificate information of the user corresponds to the common certificate information.

7. A certifying method, comprising:
pre-registering common certificate information in common with a plurality of services;
determining whether or not certificate information of the user corresponds to the common certificate information when the user accesses a particular service of the plurality of services; and
permitting the user to utilize the particular service when the certificate information of the user corresponds to the common certificate information.

8. A certificating system, comprising:
registering means for registering common certificate information in common with a plurality of services;
receiving means for receiving certificate information of a user when the user accesses a particular service of the plurality of services;
determining means for determining whether or not the certificate information of the user corresponds to the common certificate information; and
permitting means for permitting the user to utilize the particular service when the certificate information of the user corresponds to the common certificate information.

9. A propagation signal for propagating a program to a computer, the program causing the computer to perform:
receiving certificate information of a user when the user accesses a particular service of a plurality of services;
determining whether or not the certificate information of the user corresponds to common certificate information in common with the plurality of services; and
permitting the user to utilize the particular service when the certificate information of the user corresponds to the common certificate information.
